(19) United States
(12) Patent Application Publication
(10) Pub. No.: US 2010/0085507 A1
(43) Pub. Date: Apr. 8, 2010

(54) DISPLAY APPARATUS AND METHOD OF FABRICATING THE SAME

(76) Inventors: Joo-Woan CHO, Asan-si (KR); Jac-Chang Choi, Yongin-si (KR); Seong-Sik Choi, Seoul (KR)

Correspondence Address: Haynes and Boone, LLP;IP Section, 2323 Victory Avenue, SUITE 700, Dallas, TX, 75219, US

(21) Appl. No.: 12/406,892

(22) Filed: Mar. 18, 2009

(30) Foreign Application Priority Data
Oct. 7, 2008 (KR) 2008-98209

(51) Int. Cl. G02F 1/13357; G02F 1/13

(52) U.S. Cl. 349/62; 349/187

(57) ABSTRACT

Disclosed is a display apparatus according to one or more embodiments. The display apparatus according to an embodiment includes a display panel, an optical sheet unit having a convex print pattern to maintain an interval with the display panel, and a light source supplying light to the display panel through the optical sheet unit. Each pattern of the optical sheet may be disposed on a non-display unit of the optical sheet unit.

### CROSS-REFERENCE TO RELATED APPLICATION

This application relies for priority upon and claims the benefit of Korean Patent Application No. 2008-98209 filed on Oct. 7, 2008, the contents of which are herein incorporated by reference in their entirety.

### BACKGROUND

1. Technical Field

Embodiments of the present invention generally relate to a display apparatus and a method of fabricating the same. More particularly, embodiments of the present invention relate to a display apparatus capable of minimizing an interval between a display panel and an optical sheet.

2. Description of the Related Art

Recently, with the development of various electronic appliances such as mobile phones, personal digital assistants (PDAs), computers and large-sized televisions, demands for a flat panel display apparatus applicable to the electronic appliances have been increased.

Research into the flat panel display apparatus such as a liquid crystal display (LCD), a plasma display panel (PDP), a field emission display (FED) and a vacuum fluorescent display (VFD) has been actively conducted. Among them, the LCD has been currently spotlighted due to mass production, simple driving scheme and high quality images thereof.

The LCD displays an image by using optical anisotropy of liquid crystal. In detail, the LCD displays the image by adjusting light transmittance of the liquid crystal using an electric field.

Such an LCD includes a display panel that displays an image. Since the display panel is a non-emissive device, a backlight unit is additionally required to supply light to the display panel. The backlight unit includes an optical sheet that improves the efficiency of light passing through the display panel.

An optical sheet unit having at least one optical sheet is provided at the back of the display panel, in order to control light incident into the display panel. However, if the display panel makes contact with the optical sheet, a crack or defect may occur due to friction therebetween. In order to prevent the crack or defect, the display panel may be spaced apart from the optical sheet. Thus, the LCD may have a disadvantage in terms of slimness.

### SUMMARY

Embodiments of the present invention provide an ultra slim display apparatus capable of minimizing an interval between a display panel and an optical sheet. Embodiments of the present invention also provide a method of fabricating the ultra slim display apparatus.

In one embodiment of the present invention, a display apparatus includes a display panel, a light source, an optical sheet unit and a convex print pattern. The display panel displays an image. The light source is disposed at the back of the display panel to supply light to the display panel. The optical sheet unit is disposed between the display panel and the light source to control a path of the light. The convex print pattern is formed on the optical sheet unit to maintain an interval between the display panel and the optical sheet unit.

The optical sheet unit includes a display area, through which the image is displayed, and a non-display area. The display area corresponds to a displaying area of the display panel. The non-display area may be formed around the display area. The convex print pattern may be provided on the non-display area. The convex pattern may include cured foaming ink.

The convex print pattern may surround the display area or may be formed on a part of non-display area, i.e. an area disposed around the display area. Furthermore, the convex print pattern may include opaque material. In this case, the convex print pattern may serve as a light blocking layer. The convex print pattern may have various shapes and may have a thickness of about 0.05 mm to about 1 mm. The convex print pattern includes a receiving section having a flat upper surface and may have a predetermined shape. The receiving section may have a width of about 4 mm or less.

The cured foaming ink may include cured plastisol, cured urethane or cured resin. The plastisol may include a composition containing about 30 wt % to about 60 wt % of polyvinylchloride, about 30 wt % to about 50 wt % of phthalate ester, about 10 wt % to about 20 wt % of organic or inorganic pigment, and about 10 wt % to about 30 wt % of filler.

The display apparatus may further include a polarizing plate disposed on an area of the display panel corresponding to an entire surface of the display area and a first area of the non-display area. The convex print pattern may be formed on a second area of the non-display area of the optical sheet unit. Further, the convex print pattern may be formed on a part of the second area. Furthermore, the convex print pattern may cover an entire surface of the second area of the non-display area of the optical sheet unit.

The optical sheet unit may include at least one of a protection sheet, a diffusion sheet and a prism sheet. The convex print pattern may be provided on one of the optical sheets adjacent to the display panel.

In another embodiment of the present invention, a method of fabricating a display apparatus is provided. An optical sheet is prepared. A pattern is printed on a surface of the optical sheet. The pattern is cured to form a convex print pattern. The optical sheet is provided between a display panel, which displays an image, and a light source that supplies light to the display panel. The convex print pattern may be formed using foaming ink through screen printing or gravure printing. The foaming ink may include one selected from the group consisting of plastisol ink, urethane ink and resin ink. The plastisol may include polyvinylchloride, phthalate ester, organic or inorganic pigment, and filler.

Heat or light may be applied to the pattern to cure the pattern. Thus, the foaming degree of the foaming ink varies, so that thickness of the convex print pattern may be adjusted. Heat may be applied to the pattern at the temperature of about 60° C. to about 100° C.

According to one or more embodiments of the display apparatus of the present invention, a panel gap may be maintained at a minimum size. Furthermore, a predetermined interval may be maintained between the display panel and the optical sheet while reducing the relative movement between the display panel and the optical sheet using adhesion of the receiving section, so that a defect caused by the crack of the optical sheet or a polarizing plate may be minimized. Furthermore, the convex print pattern may be easily formed through screen printing or gravure printing, so that a working process and handling of the LCD may be improved.

Thus, the display quality of the display apparatus may be improved and the manufacturing cost and time may be reduced.

### BRIEF DESCRIPTION OF THE DRAWINGS

The above and other advantages of the embodiments of the present invention will become readily apparent by reference to the following detailed description when considered in conjunction with the accompanying drawings wherein:

FIG. 1 is an exploded perspective view schematically illustrating an LCD according to an exemplary embodiment of the present invention;

FIG. 2 is a sectional view illustrating an end portion of the LCD shown in FIG. 1;

FIG. 3 is a view illustrating a convex print pattern according to an embodiment having a thickness of about 0.23 mm formed on an optical sheet having a thickness of about 0.28 mm by using foaming ink;

FIGS. 4A and 4B are plan and perspective views illustrating the shape of a convex print pattern according to a first exemplary embodiment of the present invention;

FIG. 5 is a plan view illustrating the shape of a convex print pattern in the same manner as that of FIG. 4A according to a second exemplary embodiment of the present invention;

FIG. 6 is a plan view illustrating the shape of a convex print pattern according to a third exemplary embodiment of the present invention;

FIG. 7 is a sectional view illustrating an LCD according to a fourth exemplary embodiment of the present invention; and

FIG. 8 is a plan view illustrating the shape of a convex print pattern according to a fourth exemplary embodiment of the present invention.

### DETAILED DESCRIPTION

Hereinafter, a display apparatus according to an embodiment of the present invention will be explained in detail with reference to the accompanying drawings. In an LCD of a display apparatus according to one embodiment, a light emitting diode is used as a light source and an edge-illumination type in which the light source is disposed at the lateral side of a display panel will be explained as an example. However, the scope of the present disclosure is not limited thereto. For example, various lamps such as a cold cathode fluorescent lamp (CCFL) or external electrode fluorescent lamp (EEFL) may be used as the light source. In addition, the technical scope of the present disclosure may be applied to a direct-illumination type in which a plurality of light sources are disposed below the display panel.

Hereinafter, the LCD according to an exemplary embodiment of the present invention will be explained with reference to the accompanying drawings. It should be understood that the embodiments of the present invention are not limited to the appended drawings but include all modifications, equivalents and alternatives within the spirit and scope of the present disclosure as defined in the claims. The appended drawings are not necessarily to scale, presenting a somewhat extended or reduced representation of partial elements to illustrate various layers and regions more clearly. In the figures, reference numerals refer to the same or equivalent parts of the embodiments of the present invention throughout the figures of the drawing. For the purpose of convenience, an image display direction on the display panel will be referred to as ‘an upper direction’ or ‘a front direction’ and an opposite direction thereof will be referred to as ‘a lower direction’ or ‘a rear direction’.

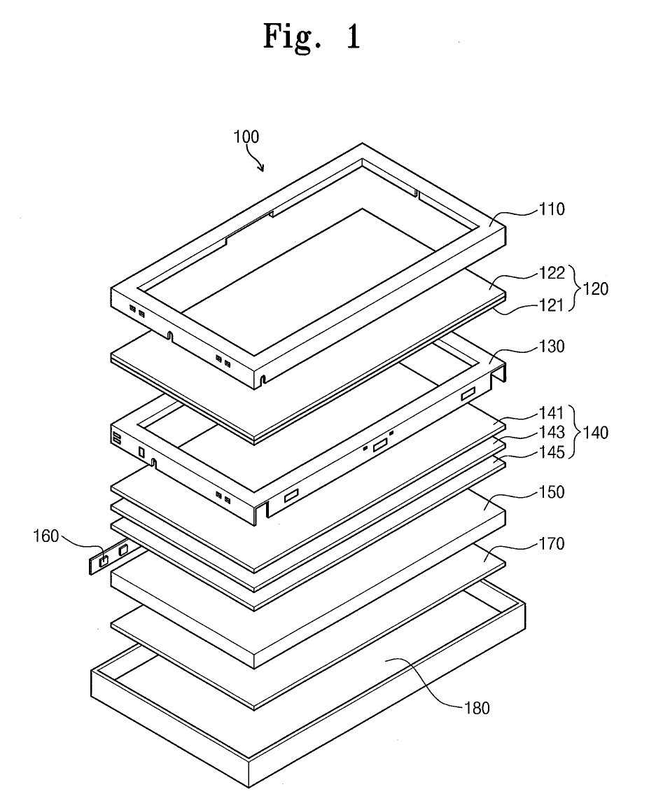

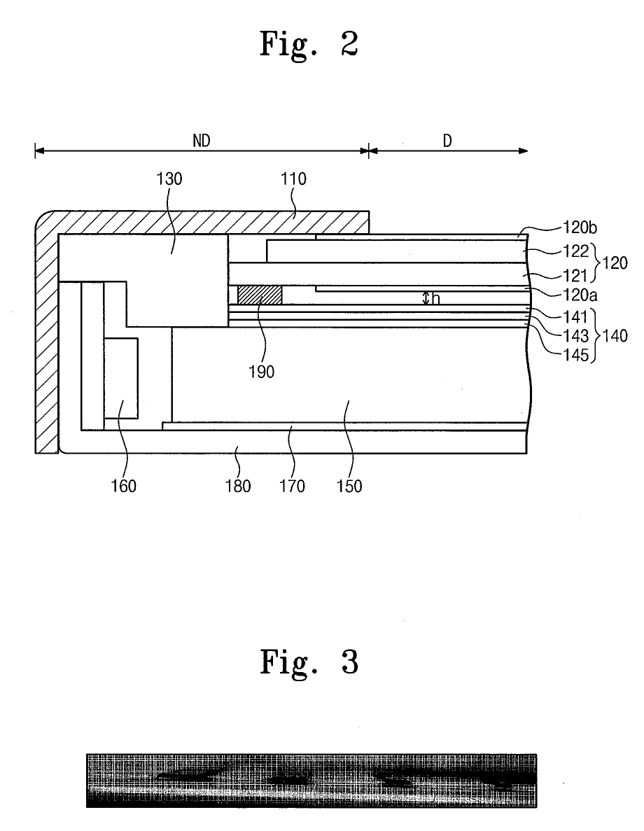

FIG. 1 is an exploded perspective view illustrating an LCD according to an exemplary embodiment of the present invention and FIG. 2 is a sectional view illustrating an end portion of the LCD shown in FIG. 1.

Referring to FIGS. 1 and 2, the LCD 100 according to an embodiment of the present invention includes a display panel 120. The display panel displays an image in the front direction thereof. A mold frame 130 is disposed at edges of the display panel 120 to support the display panel 120. An optical sheet unit 140 is disposed under the mold frame 130, i.e. in the rear direction of the display panel 120. A light source 160 is disposed on at least one side of the optical sheet unit 140, for example, on the rear portion or the lateral side of the optical sheet unit 140, to supply light to the display panel 120 through the optical sheet unit 140. The present embodiment provides an edge-illumination type in which the light source 160 is disposed at the lateral side of the optical sheet unit 140 instead of the rear portion of the optical sheet unit 140. However, the scope of the present disclosure is not limited thereto.

A light guide plate 150 is disposed between the light source 160 and the optical sheet unit 140 to guide light emitted from the light source 160 toward the optical sheet unit 140 and the display panel 120.

A reflective sheet 170 is disposed under the light guide plate 150 to reflect light that travels in a specific direction other than the front direction of the display panel 120. A lower cover 180 is disposed under the reflective sheet 170 to receive the display panel 120, the optical sheet unit 140, the light guide plate 150, the light source 160 and the reflective sheet 170 while being coupled with them. An upper cover 110 facing the lower cover 180 is coupled with the lower cover 180. The upper cover 110 may serve as a structure that supports the front edges of the display panel 120. The upper cover 110 comprises a display window that exposes a display area of the display panel 120. A plurality of coupling devices such as screw holes (not shown) may be formed at a side of the upper cover to couple with the lower cover 180.

The display panel 120 may be prepared in the form of a rectangular plate having long and short sides. The display panel 120 includes a first substrate 121, a second substrate 122 that faces the first substrate 121, and liquid crystal (not shown) formed between the first and second substrates 121 and 122. The display panel 120 displays an image in the front direction thereof by driving the liquid crystal. Furthermore, the display panel 120 includes a display area D through which the image is displayed, and a non-display area ND formed around the display area D. To drive the liquid crystal, a thin film transistor may be formed on the first substrate 121 and a color filter may be formed on the second substrate 122. In such a case, the first and second substrates 121 and 122 may be referred to as a thin film transistor substrate and a color filter substrate, respectively. The present embodiment uses a liquid crystal panel as the display panel. However, the scope of the present disclosure is not limited thereto. In detail, a different display panel requiring a light source may also be used. For example, an electrophoretic display panel may be used.

A plurality of gate lines and a plurality of data lines, which cross the gate lines, are formed in a matrix type on the first substrate 121 to define pixels. A thin film transistor is formed on a pixel area defined by the gate line and data line.

Although not shown in the drawings, a printed circuit board may be provided at one side of the display panel 120. The printed circuit board may be connected with the thin film transistor of the display panel 120. A signal output from the printed circuit board is transferred to the thin film transistor through an interconnection, so that the thin film transistor drives the liquid crystal by applying voltage to the pixels in response to the signal.

Furthermore, polarizing plates 120a and 120b are disposed on rear surfaces of the first and second substrates 121 and 122 to polarize and adjust light transmittance according to alignment of the liquid crystal, respectively. The polarizing plates 120a and 120b are attached to the entire surface of the display area D. The polarizing plates 120a and 120b extend to a part of the non-display area ND.

Since the liquid crystal is non-emissive material, the light source 160 is required to produce an image. The light irradiated from the light source 160 may include an undesired vibration vector. In this regard, the polarizing plates 120a and 120b having transmission axes thereof crossing each other at an angle of 90° are attached to both surfaces of the display panel 120 in order to adjust the vibration vector of the transmitted light. The light that passes through the liquid crystal is polarized into light having a specific vibration vector due to the polarizing plates 120a and 120b. Thus, the intensity of the transmission light varies depending on the rotation degree of a polarization axis while the light is passing through the display panel 120, so that a color having various gray scales, such as black or white, may be expressed.

The mold frame 130 is disposed along the edges of the display panel 120. The mold frame 130 has a substantially rectangular ring shape. The mold frame 130 supports the display panel 120 and the optical sheet unit 140. The mold frame 130 is coupled with the lower cover 180 to receive the optical sheet unit 140, the light guide plate 150, the light source 160 and the reflective sheet 170. As illustrated in FIGS. 1 and 2, according to an embodiment, one mold frame 130 may be formed. However, the scope of the present disclosure is not limited thereto. In detail, a plurality of mold frames 130 may be formed and be assembled.

The optical sheet unit 140 controls the light emitted from the light source 160. The optical sheet unit 140 includes at least one of a protection sheet 141, a prism sheet 143 and a diffusion sheet 145, which are positioned at the back of the display panel 120. The diffusion sheet 145 diffuses the light from the light source 160 to supply the light to the display panel 120. A plurality of protection sheets 141, a plurality of prism sheets 143 and a plurality of diffusion sheets 145 may also be used according to one or more embodiments. Moreover, two or three sets of sheets may be used by overlapping the sheets with each other. Furthermore, the protection sheet 141 may be omitted and only the diffusion sheet 145 or the prism sheet 143 may also be used.

The prism sheet 143 collects the light, which is diffused by the diffusion sheet 145, in a direction perpendicular to the plane of the display panel 120. The light that passes through the prism sheet 143 travels perpendicularly as a result, so that uniform luminance distribution may be obtained. The protection sheet 141 protects the prism sheet 143, which may be easily scratched.

The optical sheet unit 140 may include a plurality of protection sheets 141, a plurality of prism sheets 143 and a plurality of diffusion sheets 145. The protection sheet 141, the prism sheet 143 and the diffusion sheet 145 may be separately used. Furthermore, the protection sheet 141, the prism sheet 143 and the diffusion sheet 145 may also be prepared in the form of a single sheet or multiple sheets by combining functions of the three sheets 141, 143 and 145. In such a case, the three sheets 141, 143 and 145 may be used as a single sheet. Furthermore, various combinations of the three sheets 141, 143 and 145 may be realized. For instance, at least one of the three sheets 141, 143 and 145 may be removed.

A convex print pattern 190 may be formed on the optical sheet unit 140 to maintain an interval between the optical sheet unit 140 and the display panel 120, as will be described later.

The light guide plate 150 may be disposed at the back of the display panel 120 to guide the light generated from the light source 160 toward the rear surface of the display panel 120. The light guide plate 150 may have a patterned surface to allow the light emitted from the light source 160 to travel toward the display panel 120. The rear surface of the light guide plate 150 faces the reflective sheet 170, so that the light guide plate 150 changes light, which is irradiated to an incident surface from the light source 160 disposed adjacent to the incident surface, into planar light and uniformly transfers the planar light to the display panel 120 through an exit surface. In general, the light guide plate 150 may be in the form of a rectangle having long and short sides. According to another exemplary embodiment, the light guide plate 150 may be prepared in the form of a wedge. The wedge form of the light guide plate may have a thickness that is gradually reduced from one side to the other side thereof.

The light source 160 is disposed at a lateral side of the light guide plate 150. The light source 160 may be a CCFL, an external electrode fluorescent lamp (EEFL), a light emitting diode (LED) or the like. The reflective sheet 170 is disposed under the light guide plate 150. The reflective sheet 170 reflects light, which is directed downward through a lower portion of the light guide plate 150, into the upward direction.

As described above, the LCD 100 employs the light source 160 that supplies light because the display panel 120 is a non-emissive device. The light source 160 may generate light by using a linear lamp or a point-type lamp. Light from the linear lamp or the point-type lamp is changed into surface light such that the light may be used for the LCD 100. To this end, various optical sheets and an optical member such as a light guide plate may be used. The optical member changes a path of light emitted from the light source 160 to improve the efficiency of the light. According to one or more embodiments, the optical member may comprise a thick and hard type optical member such as the light guide plate. In other embodiments, the optical member may comprise a thin and soft type optical member such as the diffusion sheet. The optical members may be disposed overlapping with each other in the case of a direct-illumination type backlight unit or an edge-illumination type backlight unit.

In a case in which the display panel 120 makes direct contact with the optical sheet unit 140, when impact or vibration is applied to the display panel 120 and the optical sheet unit 140, friction occurs between the protection sheet 141 of the optical sheet unit 140 and the polarizing plate 120a of the display panel 120, causing the surface of the optical sheet unit 140 or the polarizing plate 120a to be scratched. In order to prevent the scratch, the display panel 120 is spaced apart from the optical sheet unit 140 by a predetermined interval h (hereinafter, referred to as a panel gap).

According to the related art, a rib of the mold frame 130 is provided between the display panel 120 and the optical sheet unit 140 to maintain the panel gap. In detail, the rib of the mold frame 130 is disposed on the optical sheet unit 140, and the display panel 120 is seated on the rib of the mold frame 130. Thus, the display panel 120 is spaced apart from the optical sheet unit 140 by the thickness of the rib. The panel gap has various values that vary depending on application products. In general, in the case of a television, the panel gap has a value of about 5 mm to about 10 mm. In the case of a desktop monitor, the panel gap has a value of about 2 mm to about 5 mm. In the case of a monitor of a notebook PC, the panel gap has a value of about 0.25 mm to about 1 mm.

However, when maintaining the panel gap through the mold frame 130, the panel gap cannot be easily formed with a predetermined value of thickness or less. Particularly, because an LCD has a tendency to have a large-size fabrication and slimness, the thickness of parts or an optical sheet unit in a product is reduced. However, the thickness of the display panel 120 or the optical sheet unit 140 may not be easily reduced. Furthermore, limitations may exist in the minimization of thickness of the rib of the mold frame 130. Particularly, the mold frame 130 may not be easily formed with a thickness of about 0.1 mm to about 0.3 mm.

In this regard, the panel gap may be maintained using a thin tape having a thickness of about 1 mm. However, the tape may not be easily subject to an attachment or detachment process. Furthermore, in the case of a tape having a thickness of about 1 mm or less, since the workability thereof is poor, the manufacturing cost and time are increased. To overcome these problems, a structure of bonding a display panel to an optical sheet unit is mainly used without using a mechanical structure in the related art. However, such a structure is incomplete in terms of reliability as described above. In addition, in the case of the related art, when moisture is introduced into a product, the display panel may adhere to the optical sheet unit. In such a case, since the display panel makes contact with the optical sheet unit, a crack may occur due to impurities or friction therebetween.

Thus, the interval between the display panel 120 and the optical sheet unit 140 should be reduced while maintaining a minimum interval therebetween. According to the exemplary embodiment of the present invention, a convex print pattern 190 is formed on the upper surface of the optical sheet unit 140 to maintain an interval, without using an additional element such as the rib of the mold frame 130. That is, the convex print pattern 190 is formed on the surface of the optical sheet unit 140 facing the display panel 120, so that the display panel 120 is spaced apart from the optical sheet unit 140. According to one exemplary embodiment of the present invention, the convex print pattern 190 includes cured foaming ink and is provided on the non-display area ND of the display panel 120.

The convex print pattern 190 may be prepared in the form of a hemisphere. Furthermore, the convex print pattern 190 may have a flat upper surface such that the display panel 120 may be stably received thereon.

FIG. 3 is a view illustrating the convex print pattern according to an embodiment having a thickness of about 0.23 mm formed on an optical sheet by using foaming ink. The optical sheet has thickness of about 0.28 mm in this embodiment. The convex print pattern 190 may have various shapes. If the flat upper portion of the convex print pattern 190 is referred to as a receiving section, or a seating section, the sectional shape of the convex print pattern 190 varies depending on the size (i.e. width) of the receiving section. This is caused by surface tension of the foaming ink.

The receiving section may vary depending on the size of the non-display area ND. According to one exemplary embodiment, if the non-display area ND has a size of about 4 mm, the receiving section may have a width of about 4 mm. The maximum size of the receiving section may vary if necessary according to one or more embodiments. The receiving section may be adjusted such that the display panel 120 may stably sit thereon. Since the receiving section has a flat upper surface, a contact area between the receiving section and the display panel 120 is increased, so that the display panel 120 may be efficiently supported by the receiving section. Thus, stability of the display panel 120 in view of external vibration or impact is increased.

Furthermore, the convex print pattern 190 may be prepared in the form of a closed curve on the non-display area ND along a peripheral portion of the display area D. However, the scope of the present disclosure is not limited thereto. In detail, a plurality of convex print patterns may be formed on a part of the non-display area ND along the peripheral portion of the display area D. The receiving section may have various shapes such as a cross shape, an X shape or a circular shape, for example.

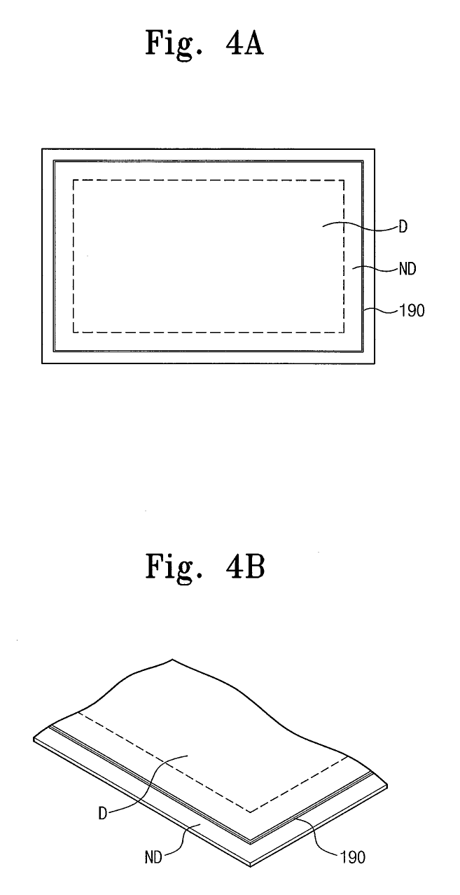

FIGS. 4A and 4B are plan and perspective views illustrating the shape of the convex print pattern according to a first exemplary embodiment of the present invention, and show only the shape of the uppermost optical sheet unit and the convex print pattern.

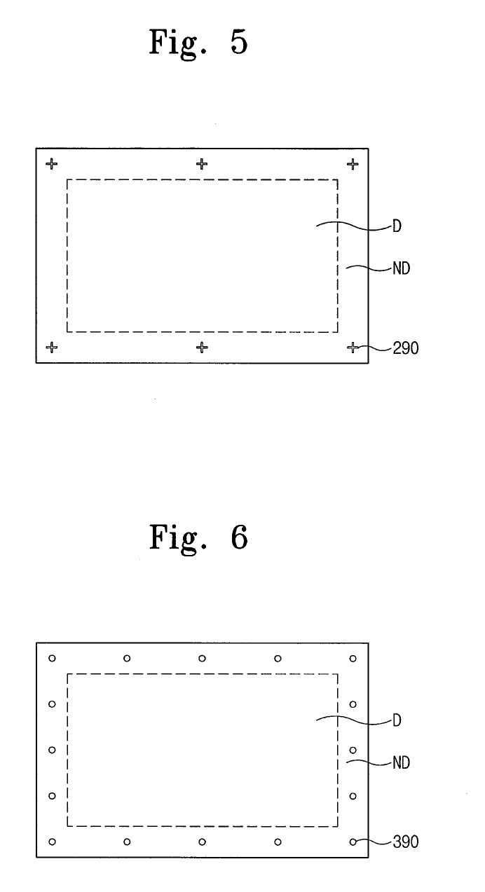

FIG. 5 is a plan view illustrating the shape of the convex print pattern in the same manner as that of FIG. 4A according to a second exemplary embodiment of the present invention.

FIG. 6 is a plan view illustrating the shape of the convex print pattern according to a third embodiment of the present invention.

As illustrated in FIGS. 4A, 4B, 5 and 6, the convex print patterns 190, 290 and 390 according to the first to third embodiments of the present invention have various shapes. Furthermore, at least one convex print pattern may be formed at various positions in the non-display area ND.

The convex print patterns 190, 290 and 390 may be formed with various thicknesses according to the printed thickness of the foaming ink and the generation degree of bubbles during a curing reaction of the foaming ink. However, when the convex print patterns 190, 290 and 390 have excessively thick thicknesses, the entire thickness of the display panel 120 may be increased. In this regard, according to one exemplary embodiment, the convex print patterns 190, 290 and 390 may have thicknesses of about 0.05 mm to about 1 mm.

Since the foaming ink includes a high-molecular monomer or a precusor, a polymer may be formed when a curing reaction occurs. Further, a foaming agent added into the ink may include a material, such as azobisisobutyronitrile that generates gas when decomposition of that material occurs by heat. A foaming agent such as ester-based, azo-based, hydrazide-based, nitroso-based compound or the like may be used. In addition, volatile liquid encapsulated by a thermoplastic resin microcapsule may be used as the foaming agent by destroying the microcapsule by heat or pressure to generate gas.

The foaming ink including the foaming agent may include plastisol ink, urethane ink, or resin ink, which has a foaming property. The foaming ink may be cured with heat or light such as ultraviolet rays. In the curing process, gas may be generated.

According to one exemplary embodiment of the present invention, plastisol ink may be used. The plastisol ink may include a composition containing about 30 wt % to about 60 wt % of polyvinylchloride, about 30 wt % to about 50 wt % of phthalate ester, about 10 wt % to about 20 wt % of organic or inorganic pigment, and about 10 wt % to about 30 wt % of filler.

The gas generated through the curing process is dispersed between cured polymers if the curing process is completed. Thus, bubbles are positioned between the polymers of the cured foaming ink, so that the cured foaming ink has elasticity by the dispersed bubbles. The bubbles serve as a buffer that reduces impact or vibration transferred to the display panel 120 or the optical sheet unit 140 when impact or vibration is applied to the LCD 100.

Furthermore, if viscosity is added to the foaming ink, sliding between the display panel 120 and the optical sheet unit 140 decreases, so that a defect, such as a crack of the optical sheet unit 140 or a crack of the polarizing plate 120a due to relative movement, may be reduced.

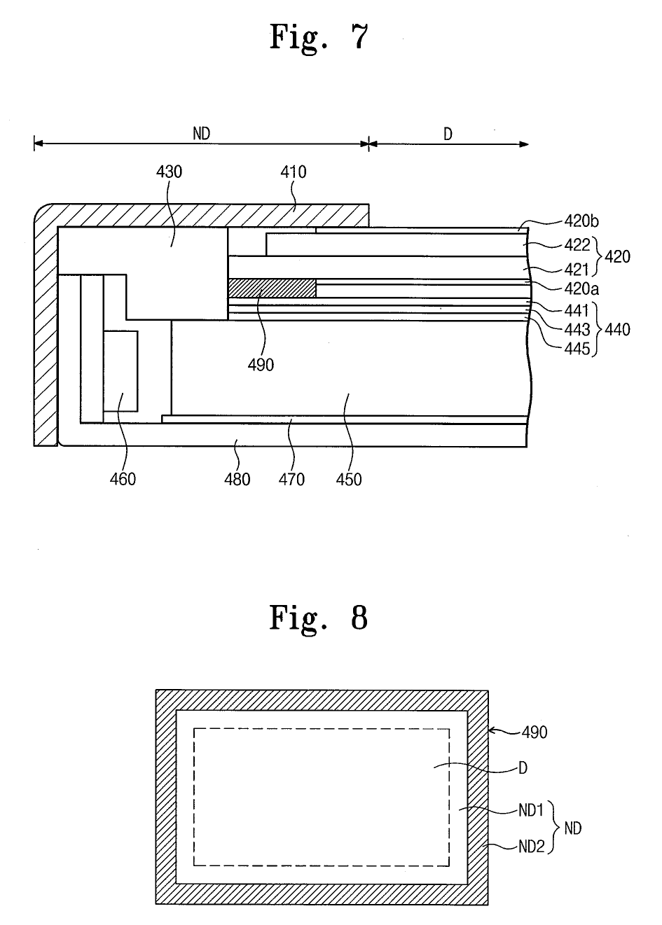

The convex print pattern may not only maintain the interval between the display panel 120 and the optical sheet unit 140, but it may also prevent light from being output in a specific direction other than the front direction of the display panel 120. FIG. 7 is a sectional view illustrating the LCD according to a fourth exemplary embodiment of the present invention, in which a convex print pattern 490 may serve as a light blocking section. FIG. 8 is a plan view illustrating the shape of the convex print pattern according to the fourth exemplary embodiment of the present invention, which shows only the shape of the uppermost optical sheet unit and the convex print pattern.

In the fourth embodiment, only features different from those of the first embodiment will be described and description of elements that are the same as those of the first embodiment will be omitted in order to avoid redundancy.

Referring to FIGS. 7 and 8, polarizing plates 420a and 420b are attached on both surfaces of the display panel 420. The polarizing plates 420a and 420b cover the entire surface of the display area D and extend to a part of the non-display area ND from the display area D. According to the present embodiment, light emitted from the light source 460 travels toward the display panel 420 via the optical sheet unit 440. At this time, some light may travel toward the display panel 420 having no lower polarizing plate 420a and a lateral side of the polarizing plate 420a.

According to the present embodiment, the entire surface of an upper portion of the optical sheet unit 440 on the non-display area ND having no polarizing plates is covered with a convex print pattern 490 to prevent leakage of light. In detail, if an area of the non-display area ND, which is defined by extension parts of the polarizing plates 420a and 420b, refers to a first area ND1, and an area having no polarizing plates 420a and 420b refers to a second area ND2, the convex print pattern 490 covers an entire surface of the second area ND2.

The convex print pattern 490 may include opaque material to maximize light blocking efficiency.

As described above according to one or more embodiments, the optical sheet unit 440 may include at least one of a protective sheet 441, a prism sheet 443 and a diffusion sheet 445. A plurality of protective sheets 441, a plurality of prism sheets 443 and a plurality of diffusion sheets 445 may be used in other embodiments. The convex print pattern 490 is formed on the surface of the protective sheet 441, which is nearest to the display panel 420, to maintain an interval between the display panel 420 and the optical sheet unit 440.

Furthermore, the convex print pattern 490 may also be formed when different elements are to be spaced apart from each other. For example, the convex print pattern 490 may be formed between the optical sheets, e.g. between the diffusion sheet 445 and the prism sheet 443. Further, the convex print pattern 490 may also be formed between the optical sheet and the light guide plate.

The present disclosure provides a method of fabricating the LCD having the above structure according to one or more embodiments. The method of fabricating the LCD according to one embodiment of the present invention includes preparing and assembling the display panel, a light source and the optical sheet.

The optical sheet is prepared by curing foaming ink on the surface of the optical sheet to form the convex print pattern. Since the foaming ink contains a foaming agent therein, the foaming ink generates gas under specific conditions after a printing process, e.g. if heat or light such as ultraviolet rays is applied thereto. The foaming ink may be cured with heat or light as described above according to one or more embodiments. However, the scope of the present disclosure is not limited thereto. The foaming ink may be used if the ink can generate gas and be cured.

Since the foaming ink includes a high-molecular monomer or a precusor, a polymer may be formed when a curing reaction occurs. Furthermore, a foaming agent added into the ink may include a material, such as azobisisobutyronitrile that generates gas while being decomposed by heat. The foaming agent may contain ester-based, azo-based, hydrazide-based, nitroso-based compound or the like. In addition, volatile liquid may be encapsulated by a thermoplastic resin microcapsule and may be used as the foaming agent by destruction of the microcapsule by heat or pressure to generate gas.

The foaming ink including the foaming agent may include plastisol ink, urethane ink, or resin ink, which has a foaming property. The foaming ink may be cured using heat or light such as ultraviolet rays. In the curing process, gas may be generated.

According to one embodiment of the present invention, plastisol ink may be used. The plastisol ink may include a composition containing about 30 wt % to about 60 wt % of polyvinylchloride, about 30 wt % to about 50 wt % of phthalate ester, about 10 wt % to about 20 wt % of organic or inorganic pigment, and about 10 wt % to about 30 wt % of filler.

The foaming ink may have a liquid phase with viscosity and may be formed on the optical sheet unit by using a printing method such as screen printing or gravure printing. However, the scope of the present disclosure is not limited thereto.

The screen printing or the gravure printing refers to intaglio printing. According to the screen or the gravure printing, ink is filled in a hole part or a concave part of a plate, and unnecessary ink on a protruding part of the plate is gathered up using a squeegee, so that the ink in the concave part is transferred to a printed matter, such as the optical sheet unit according to one or more embodiments of the present invention. The screen or the gravure printing is used to prevent ink from widely spreading due to pressure, so that a desired pattern can be formed at a desired position, differently from relief printing. Furthermore, when considering that volume of the foaming ink is increased through the curing process, if the relief printing is used, a pattern may be formed on a specific area other than an area on which the pattern is to be formed. In this regard, forming of the unnecessary pattern may be minimized using the screen or the gravure printing. Thus, according to one embodiment of the present invention, the screen or the gravure printing may be used to precisely form the convex print pattern at a desired position. The foaming ink formed on the optical sheet unit may serve as a support member that maintains the interval between the display panel and the optical sheet unit through the curing reaction. The curing reaction may occur with light or heat, i.e. photocurable or thermosetting reaction may occur. During the curing reaction, the foaming ink may generate gas.

The gas generated through the curing process is dispersed between cured polymers if the curing process is completed. Thus, bubbles are positioned between the polymers of the cured foaming ink, so that the cured foaming ink has elasticity by the dispersed bubbles. The bubbles serve as a buffer that reduces impact or vibration transferred to the display panel or the optical sheet unit when impact or vibration is applied to the LCD.

When the curing reaction refers to thermosetting reaction, the curing reaction may be performed at various temperatures according to the type of the foaming ink. For example, according to one exemplary embodiment of the present invention, the curing temperature is about 60° C. to about 100° C.

Since the reaction degree of the convex print pattern may be determined by light or heat, the generation degree of resultant gas varies. Thus, height or volume of the protruding part may be adjusted.

The prepared optical sheet as described above according to one or more embodiments may be disposed between the display panel and the light source to complete fabrication of the LCD.

In the LCD according to the embodiments of the present invention as described above, the convex pattern having a predetermined thickness is printed on the uppermost optical sheet and the display panel is seated on the convex print pattern, so that the panel gap may be maintained at a minimum size. Thus, a predetermined interval may be maintained between the display panel and the optical sheet while reducing relative movement between the display panel and the optical sheet unit using adhesion of the receiving section, so that a defect due to, for example, a crack of the optical sheet unit or the polarizing plate, may be minimized.

Furthermore, the convex print pattern may be easily formed through screen printing or gravure printing, so that workability and handling of the LCD may be improved. Particularly, the workability and handling of the LCD may be relatively improved as compared with a case of maintaining the interval between the display panel and the optical sheet unit by attaching a tape having a predetermined thickness. Further, in order to maintain the interval between the display panel and the optical sheet unit by attaching the tape, a process of detaching a tape from an area that does not require the tape is additionally required after the film attachment process. However, according to the exemplary embodiments of the present invention, the additional detachment process may be omitted, so that the manufacturing time and cost may be reduced.

Furthermore, according to one or more embodiments of the present invention, the convex print pattern may be formed on the surface of the optical sheet by using a printing method, so that the convex print pattern may be easily formed on the optical sheet. In detail, since the optical sheet may be prepared in the form of a roll, a process of untying the roll and a process of printing the convex print pattern on the surface of the optical sheet may be simultaneously performed. Thus, the manufacturing time may be significantly shortened as compared with the tape attachment process, and the product yield may also be improved.

The convex print pattern may be formed using a gravure printing method or a screen printing method. According to the gravure printing method or the screen printing method, a pattern may be formed at a desired position without spreading of ink, differently from a relief printing method or a lithographic printing method in which ink may spread because the ink is pressed. This is caused by characteristics of the screen printing method or the gravure printing method in which ink may be filled in a concave part and unnecessary ink on a protruding part may be gathered up using a squeegee.

Although exemplary embodiments of the present invention have been described, it is understood that the present disclosure should not be limited to these exemplary embodiments but various changes and modifications may be made by one ordinary skilled in the art within the spirit and scope of the present disclosure as hereinafter claimed.

What is claimed is:

1. A display apparatus comprising:
a display panel to display an image;
a light source disposed at back of the display panel to supply light to the display panel;
an optical sheet unit disposed between the display panel and the light source to control a path of the light; and
a convex print pattern on the optical sheet unit to maintain an interval between the display panel and the optical sheet unit,
wherein the convex print pattern comprises cured foaming ink.

2. The display apparatus of claim 1, wherein the optical sheet unit comprises a display area through which the image is displayed, and a non-display area surrounding the display area, and the convex print pattern is provided on the non-display area.

3. The display apparatus of claim 2, wherein the convex print pattern surrounds the display area.

4. The display apparatus of claim 3, wherein the convex print pattern is opaque.

5. The display apparatus of claim 2, wherein the convex print pattern is formed on a part of the non-display area.

6. The display apparatus of claim 2, wherein the cured foaming ink comprises cured plastisol, cured urethane or cured resin.

7. The display apparatus of claim 6, wherein the plastisol comprises polyvinylchloride, phthalate ester, organic or inorganic pigment, and filler.

8. The display apparatus of claim 7, wherein the plastisol comprises about 30 wt % to about 60 wt % of polyvinylchloride, about 30 wt % to about 50 wt % of phthalate ester, about 10 wt % to about 20 wt % of organic or inorganic pigment, and about 10 wt % to about 30 wt % of filler.

9. The display apparatus of claim 2, wherein the convex print pattern comprises a receiving section having a flat upper surface and a predetermined shape.

10. The display apparatus of claim 9, wherein the receiving section has a width of about 4 mm or less.

11. The display apparatus of claim 2, further comprising a polarizing plate provided on an area of the display panel corresponding to an entire surface of the display area and a first area of the non-display area, and wherein the convex print pattern is provided on a second area of the non-display area of the optical sheet unit.

12. The display apparatus of claim 11, wherein the convex print pattern covers an entire surface of the second area of the non-display area of the optical sheet unit.

13. The display apparatus of claim 1, wherein the optical sheet unit comprises at least one of a protection sheet, a diffusion sheet and a prism sheet, and the convex print pattern is provided on an optical sheet adjacent to the display panel.

14. The display apparatus of claim 1, wherein the convex print pattern has a thickness of about 0.05 mm to about 1 mm.

15. A method of fabricating a display apparatus, the method comprising:
preparing an optical sheet;
printing a pattern on a surface of the optical sheet;
curing the pattern to form a convex print pattern; and
disposing the optical sheet between a display panel and a light source, the display panel displaying an image and the light source supplying light to the display panel,
wherein the convex print pattern maintains an interval between the display panel and the optical sheet.

16. The method of claim 15, wherein the convex print pattern is formed using foaming ink through screen printing or gravure printing.

17. The method of claim 15, wherein the foaming ink comprises one selected from the group consisting of plastisol ink, urethane ink and resin ink.

18. The method of claim 17, wherein the plastisol ink comprises polyvinylchloride, phthalate ester, organic or inorganic pigment, and filler.

19. The method of claim 15, wherein the pattern is cured at a temperature of about 60° C. to about 100° C.

20. The method of claim 15, wherein the convex print pattern has a thickness varying depending on an amount of time for which the light or heat is applied to the convex print pattern.
